(19) United States
(12) Patent Application Publication
(10) Pub. No.: US 2018/0372845 A1
(43) Pub. Date: Dec. 27, 2018

(54) Deflection Device for a Lidar Sensor

(71) Applicant: Robert Bosch GmbH, Stuttgart (DE)

(72) Inventors: Frank Kaestner, Bietigheim-Bissingen (DE); Siegwart Bogatscher, Sersheim (DE); Hans-Jochen Schwarz, Stuttgart (DE); Jan Sparbert, Rutesheim (DE)

(21) Appl. No.: 16/066,745

(22) PCT Filed: Nov. 15, 2016
(86) PCT No.: PCT/EP2016/077773

§ 371 Date: Jun. 28, 2018

(30) Foreign Application Priority Data
Dec. 29, 2015 (DE) 10 2015 226 771.7

(51) Int. Cl. G01S 7/481; G01S 17/93

(52) U.S. Cl. CPC G01S 7/4814; G01S 17/936; G01S 7/4817

(57) ABSTRACT

A deflection device for a Lidar sensor includes an optical main element and at least one optical placement element. The deflection device is configured to illuminate, in a defined manner, a field of view of the Lidar sensor. A defined number of image points of the field of view can be placed in a defined manner by the at least one optical placement element.

The invention relates to a deflection device for a lidar sensor. The invention furthermore relates to a lidar sensor. The invention furthermore relates to a method for producing a deflection device for a lidar sensor.

### PRIOR ART

Known in the prior art are lidar sensors (for example in the motor vehicle field) which guide transmission light into the environment via a deflection mirror (or transmission optics) and in the process capture reflected radiation. The mirror or an imaging can in this case be a planar or “simply” curved surface.

### DISCLOSURE OF THE INVENTION

It is an object of the invention to provide an improved deflection device for a lidar sensor.

In accordance with a first aspect, the invention provides a deflection device for a lidar sensor, having:
an optical main element; and
at least one optical placement element;
wherein the deflection device is embodied to light a field of view of the lidar sensor in a defined fashion;
wherein a defined number of image points of the field of view are placeable in a defined fashion using the optical placement element.

This advantageously provides support for a lighting region of the lidar sensor being specifically expandable, wherein in particular limited movement capacity of a movable micromirror can be supplemented. It is consequently possible to light peripheral regions of a field of view, which may not be highly resolving, but are capable of detecting the presence of objects or persons in the peripheral regions. The safety of a motor vehicle having a lidar sensor with the proposed deflection device can in this way be advantageously increased.

In accordance with a second aspect, the object is achieved by way of a method for producing a deflection device for a lidar sensor, having the steps of:
providing an optical main element;
providing at least one optical placement element;
wherein the optical placement element is arranged in relation to the optical main element such that a defined field of view is able to be lit using the deflection device;
wherein a defined number of image points of the field of view are placeable in a defined manner using the optical placement element.

Preferred embodiments of the deflection device are the subject of dependent claims.

A preferred embodiment of the deflection device is characterized in that the optical placement element is arranged in a corner region of the optical main element. As a result, a specifically definable expansion of a main lighting region of the optical main element can be provided. This furthermore advantageously supports the provision that regions must be displaced or rearranged by angles that are as small as possible.

A further preferred embodiment of the deflection device is characterized in that a horizontal extent of the field of view is expandable using the optical placement element. This way, a detection region of a lidar sensor can be advantageously expanded, as a result of which a safety level of a motor vehicle is advantageously increased.

A further preferred embodiment of the lighting apparatus is characterized in that image points of the field of view which are placed using the optical placement element are formed such that they are elongate. In this way, an advantageous expansion of a capturing region of the lidar sensor is able to be implemented, because, even though the resolution is not high by means of the elongate image points, a possibility for detecting moving objects is provided. Safety and assistance systems in motor vehicles can be correspondingly adapted in this way.

A further preferred embodiment of the deflection device is characterized in that the optical placement element is embodied as a reflective, or as a refractive, or as a diffractive optical element. This supports the provision that different optical principles can be used to implement targeted forms of the field of view.

A further preferred embodiment of the deflection device is characterized in that the deflection device has a reflective and/or a refractive and/or a diffractive optical placement element. This supports the provision that different optical principles can be used to implement targeted forms of the field of view.

A further preferred embodiment of the deflection device is characterized in that the deflection device has placement properties only starting from a defined distance between the deflection device and the field of view. This advantageously supports the provision that a plurality of separate optical main elements are not necessary. This supports the provision that the deflection device can be technically implemented in one piece with integrated placement elements.

The invention will be described in detail below with further features and advantages based on a plurality of figures. All disclosed features, independent of their back reference in the patent claims and independent of their illustration in the description and in the figures, form the subject matter of the present invention. Identical or functionally identical components have the same reference sign. The figures are in particular intended to illustrate the principles that are essential to the invention and are not necessarily illustrated to scale.

Disclosed apparatus features can be gathered analogously from corresponding disclosed method features, and vice versa. That means in particular that features, technical advantages and embodiments with respect to the deflection device can be gathered analogously from corresponding embodiments, features and advantages of the method for producing the deflection device, and vice versa.

In the figures:

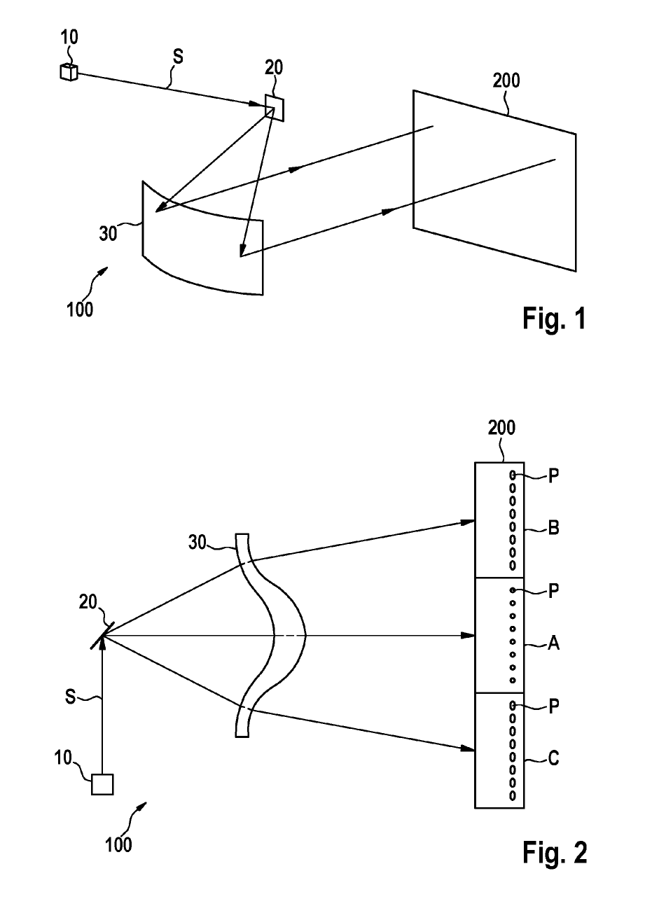

FIG. 1 shows a lighting apparatus having a conventional deflection device for a lidar sensor;

FIG. 2 shows a further lighting apparatus having a further conventional deflection device for a lidar sensor;

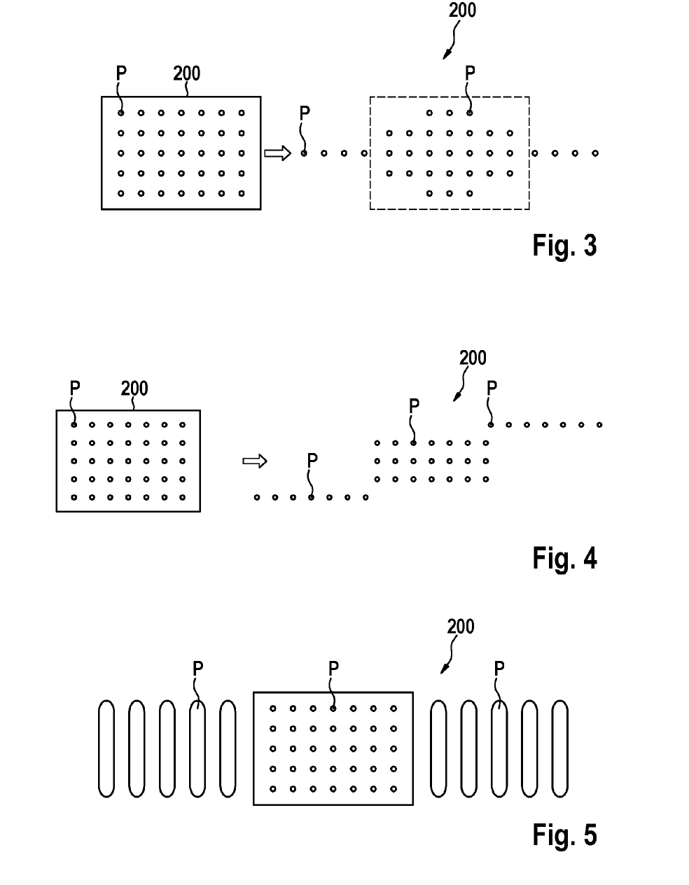

FIGS. 3-5 show different exemplary fields of view or lighting regions, which are implementable with the proposed deflection device;

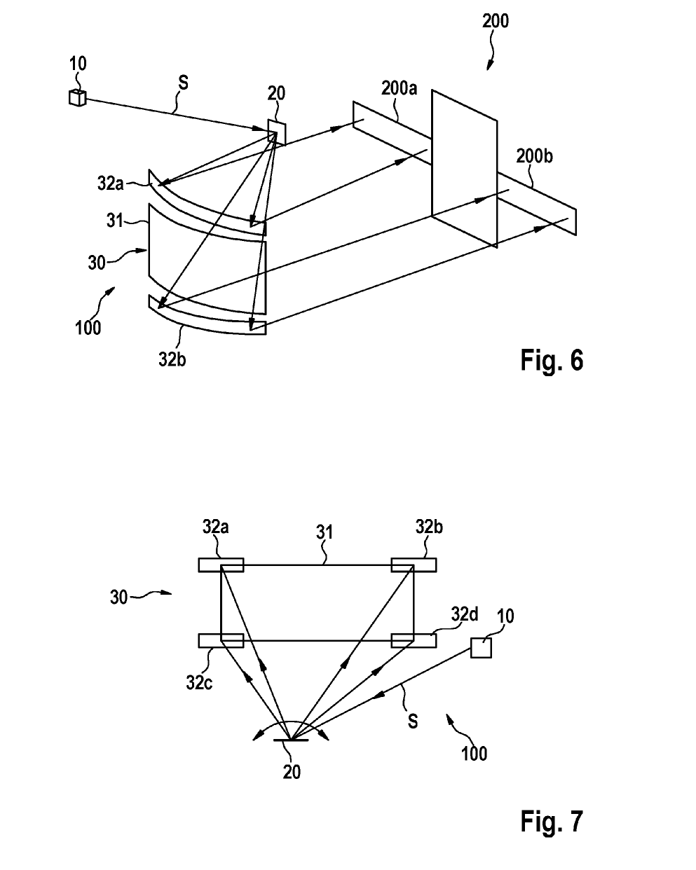

FIG. 6 shows a lighting apparatus with a first embodiment of a deflection device for a lidar sensor;

FIG. 7 shows a lighting apparatus with a second embodiment of a deflection device for a lidar sensor;

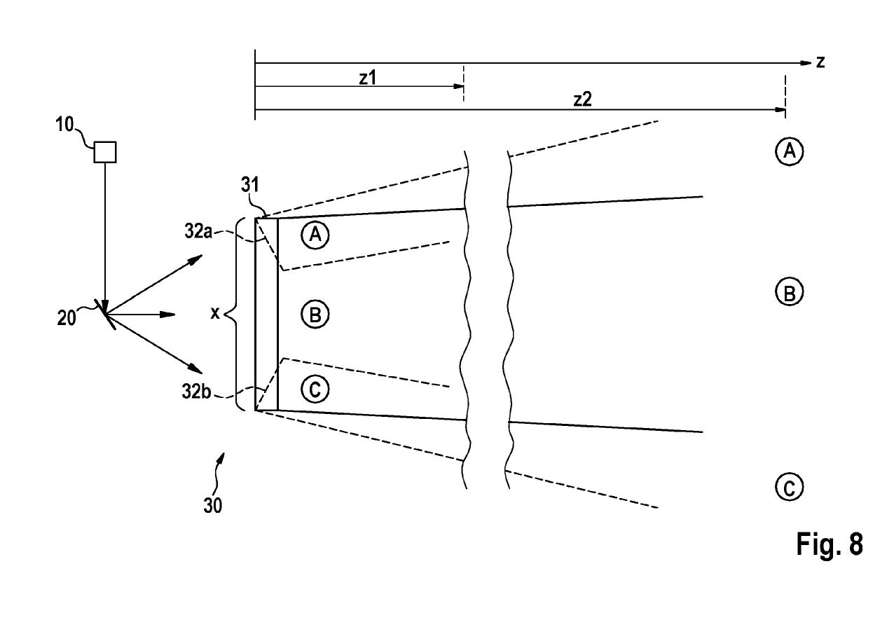

FIG. 8 shows a schematic illustration of a fundamental mode of action of the deflection device; and

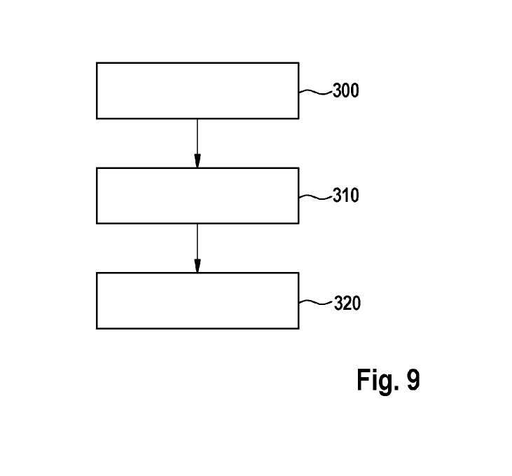

FIG. 9 shows a flow chart of an embodiment of a method for producing a deflection device for a lidar sensor.

### DESCRIPTION OF EMBODIMENTS

FIG. 1 shows in principle a setup of a lighting apparatus 100 with a conventional deflection device 30 for a lidar sensor. The lighting apparatus 100 comprises a radiation-generating device 10, preferably a laser, which emits an electromagnetic transmission beam S in the form of light onto a movable micromirror 20. The transmission beam S is reflected by the micromirror 20 onto the deflection device 30 in the form of a reflective mirror, which lights a field of view or a lighting region 200 (FOV). The field of view 200 can be formed in a defined manner in terms of its size using the deflection device 30. A basic form of the field of view 200 here substantially corresponds to a basic form of the deflection device 30. A periodic movement of the micromirror 20 results in the transmission beam S being guided over the deflection device 30 and consequently lighting the entire field of view 200. The transmission beam S is reflected at an object (not illustrated) arranged in the field of view 200, wherein reflected radiation is captured and used for ascertaining the distance of the object. FIG. 1 shows a deflection device 30 in accordance with the reflection principle.

FIG. 2 shows a further lighting apparatus 100 with a further conventional deflection device 30, which is embodied in accordance with the transmission principle. In this case, the deflection device 30 consists of transmission optics which have converging properties for the transmission beam S at the center and spreading or widening properties for the transmission beam S at the periphery. In this way, it is possible to achieve that, as is illustrated in principle in FIG. 2, the central region A of the field of view 200 has round image or scan points P and the peripheral regions B, C of the field of view 200 have image or scan points P that are spread or have an elongate oval form.

What is proposed is a change of the lit region or the field of view 200 such that, a predefined capturing region can be implemented for the lidar sensor. As a result, adaptation of transmission and receiving optics of the lidar sensor can thus be implemented, which makes possible any desired redistribution and form change of scan points P in the field of view 200.

The “mechanical” field of view prescribed by a deflecting unit in the form of the movable micromirror 20 is adapted by an optical element that is mounted in the optical path such that the image points are formed in a capturing region which is really of interest.

For the optical element, a plurality of physical possibilities exist: reflective (e.g. mirror), refractive (e.g. transmission optics), diffractive (e.g. diffractive optical element, DOE).

The peripheral region of the field of view 200 is typically not needed in a high resolution. What is important, for example, when using a lidar sensor with the deflection device in the motor vehicle, is early detection of vehicles cutting into a driving path of the vehicle. The closer the other vehicle is, the more danger it poses for the ego vehicle. The shorter the distance of the other vehicle to the ego vehicle, the larger it appears as an object. Since it is a large object, it will fill the entire vertical field of view. For this reason, high vertical resolution is in this case not necessary. More important is the expansion of the horizontal field of view of the lidar sensor. At the center of the image, all vertical image points are then captured again according to the mechanical field of view in order to allow object capturing or free-area detection with as high a resolution as possible.

FIGS. 3 to 5 show various possibilities of changing the field of view 200, in particular to a horizontal widening of the field of view 200. A number of image points P of the changed field of view 200 in all variants shown is preferably the same as a number of image points P of the original field of view 100.

FIG. 3 shows, on the left, a conventional field of view 200, such as can be realized for example with a deflection device 30 of FIG. 1. In the right-hand region of FIG. 3, a changed field of view 200 can be seen, in which the upper region is missing image points P, which have been added at the central region on the left and right.

FIG. 4 shows a further variant of a changed field of view 200. In this case, the uppermost and bottommost lines of the image points P of the field of view 200 are in each case added to the field of view 200 with an offset at the top and at the bottom.

FIG. 5 shows a further variant of a changed field of view 200, wherein in this variant, regions with image points P which are spread in the vertical direction are inserted to the left and right of the main field. In this way, a low vertical sensitivity and an increased horizontal sensitivity of the lighting apparatus 100 (not illustrated) are supported.

In this way, capturing of regions to the left and right beyond the original region of the field of view 200 is made possible with all previously mentioned changed fields of view 200, which means a horizontal expansion of the field of view 200. As a result, a lidar system having a broader field of view or detection region has been made possible, which is able in particular to better capture moving objects.

FIG. 6 shows a lighting apparatus 100 with a first embodiment of a deflection device 30 for a lidar system. In the figure, the deflection device 30 comprises an optical main element 31 and optical placement elements 32a, 32b, which are added to the optical main element 32, or integrated therein, in the form of optical wedge-shaped optics. As a result, in this way a kind of “split” optics of the deflection device 30 is provided. What is supported in this way is that an upper placement element 32a lights a left-hand region 200a of the field of view 200. A lower placement element 32b makes possible that a transmission beam lights the right-hand region 200b of the field of view 200. As a result, the total field of view can be horizontally expanded.

FIG. 7 shows a lighting apparatus 100 having a radiation-generating device 10 with a further embodiment of a proposed deflection device 30. In the figure, overall four placement elements 32a . . . 32d are provided, which are arranged in corner regions of the deflection device 30, which light corner regions of the field of view 200 (not illustrated).

With said deflection devices 30, a desired transformation from “mechanical” into “real” capturing regions (rectangular to round etc.) is possible via reflective optical elements, the reflection region of which can be a defined geometric or a defined optical free-form surface. To implement the desired effects, a defined number of reflective and/or transmissive and/or diffraction-changing elements can be used. Furthermore, any desired combination of said elements is also possible for this purpose.

FIG. 8 shows schematically that, to achieve the proposed effect of the deflection device 30, a defined minimum distance z2 of the field of view 200 from the deflection device 30 is necessary. In the case that the distance z1 is too low, the regions A, B, C of the field of view 200 are arranged so as to overlap one another (“near range”). Only in the “far range” at a distance z2, which corresponds to approximately ten times the geometric diameter x of the deflection device 30, do the regions A, B, C of the field of view 200 become separately visible. What is supported in this way is that the deflection device 30 can be configured as a unipartite device which has separate, or integrated, placement elements 32a . . . 32d.

FIG. 9 shows a flow chart of an embodiment of the proposed method for producing a deflection device 30 for a lidar sensor.

In a step 300, an optical main element 30 is provided.

In a step 310, at least one optical placement element 32a . . . 32d is provided.

In a step 320, the optical placement element 31a . . . 31d is arranged in relation to the optical main element 30 such that, using the deflection device 30, a defined field of view 200 is able to be lit, wherein a defined number of image points of the field of view are placeable in a defined manner using the optical placement element 32a . . . 32d.

The order in which the optical main element 30 and the at least one optical placement element 32a . . . 32d are provided is advantageously freely selectable.

As a result, improved transmission optics for a lidar sensor are provided in this way, wherein it is to be understood that a plurality of transmission optics can also be used in combination for the lidar sensor.

In summary, an improved deflection device for a lidar sensor is provided with the present invention, with which multifarious possibilities for a light redistribution in lidar systems are implementable, wherein the deflection device allows an expansion of the limited micromirror movement capabilities. The lidar sensor in the proposed deflection device can be used preferably in the motor vehicle field for distance and speed measurement of objects.

As a result, an improved lidar sensor is implementable hereby, which provides a specifically expanded capturing region and consequently can significantly increase a safety level of the motor vehicle. In particular, it is feasible for example that, during detection of objects, preconditioning of a vacuum servo or another assistance system of the motor vehicle is performed.

A person skilled in the art will know that a multiplicity of modifications of the invention are possible without deviating from the core of the invention.

1. A deflection device for a lidar sensor, having the deflection device comprising:
an optical main element; and
at least one optical placement element, wherein:
the deflection device is configured to light a field of view of the lidar sensor in a defined fashion, and
a defined number of image points of the field of view is placeable in a defined fashion using the at least one optical placement element.

2. The deflection device as claimed in claim 1, wherein the at least one optical placement element is arranged in a corner region of the optical main element.

3. The deflection device as claimed in claim 1, wherein a horizontal extent of the field of view is expandable using the at least one optical placement element.

4. The deflection device as claimed in claim 1, wherein image points of the field of view, which are placed using the at least one optical placement element, are formed so as to be elongate.

5. The deflection device as claimed in claim 1, wherein the at least one optical placement element one of a reflective, a refractive or a diffractive optical element.

6. The deflection device as claimed in claim 5, wherein the deflection device has at least one of a reflective and/or a refractive, and a diffractive optical placement element.

7. The deflection device as claimed in claim 1, wherein the deflection device exhibits placement properties only from a defined distance between the deflection device and the field of view.

8. The deflection device as claimed in claim 7, wherein the defined distance between the deflection device and the field of view is approximately ten times an optical extent of the deflection device.

9. A lidar sensor, having comprising:
a deflection device, including:
an optical main element; and
at least one optical placement element, wherein:
the deflection device is configured to light a field of view of the lidar sensor in a defined fashion, and
a defined number of image points of the field of view is placeable in a defined fashion using the at least one optical placement element.

10. A method for producing a deflection device for a lidar sensor, the method comprising:
providing an optical main element; and
providing at least one optical placement element, wherein:
the at least one optical placement element is arranged in relation to the optical main element such that a defined field of view is able to be lit using the deflection device; and
a defined number of image points of the field of view is placeable in a defined manner using the at least one optical placement element.
